(19) United States
(12) Patent Application Publication
(10) Pub. No.: US 2009/0259929 A1
(43) Pub. Date: Oct. 15, 2009

(54) SYSTEM AND METHOD FOR SUBMITTING A PATENT APPLICATION ELECTRONICALLY

(75) Inventors: CHUNG-I LEE, Tu-Cheng (TW); HAI-HONG LIN, Shenzhen City (CN); DE-YI XIE, Shenzhen City (CN); ZHENG-CAI ZHU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO,. LTD., Shenzhen City (CN); HON HAI PRECISION INDUSTRY CO., LTD., Tu-Cheng (TW)

(21) Appl. No.: 12/491,252

(22) Filed: Jun. 25, 2009

Related U.S. Application Data
(63) Continuation-in-part of application No. 11/614,986, filed on Dec. 22, 2006.

(30) Foreign Application Priority Data
Jan. 16, 2006 (CN) 200610033108.6

(51) Int. Cl. G06F 17/20; G06F 15/16

(52) U.S. Cl. 715/226; 709/219; 715/234

(57) ABSTRACT

A system and method for submitting a patent application electronically includes converting a specification and figures of the patent application saved in a storage device into an application body extensible (ABX) word file, converting the ABX word file into an extensible markup language (XML) file and a portable document format (PDF) file, downloading patent details of the patent application from the storage device. The method further includes inputting the patent details to each textbox on a patent submission webpage of a designated patent office website, reading a title of the patent application and the number of claims from the XML file and the PDF file, and creating XML nodes of the patent details for the XML file to obtain an application file package, transferring the application file package to a remote server located at a designated patent office.

### CROSS-REFERENCE TO RELATED APPLICATIONS

This application is a continuation-in-part application of U.S. Ser. No. 11/614,986, filed Dec. 22, 2006.

### BACKGROUND

1. Technical Field

Embodiments of the present disclosure relate to systems and methods for file transmission, and particularly to a system and method for submitting a patent application electronically.

2. Description of Related Art

Patent applications are submitted to a designated patent office. Usually, the patent applications are submitted through the post office. However, submitting applications through the post office requires a long time. Furthermore, before submitting the patent applications, manual preparation of necessary paperwork is time consuming.

One way of submitting patent applications utilizes a method to transfer patent information electronically through a network. However, the present method requires input of patent details (e.g., inventors, a patent type, and a patent agent) on a web page of an official website (e.g., USPTO) manually by an attorney, and manual formatting of the application. Workload of the submitting authority is increased due to the manual operation, and the attorney may make mistakes due to the repetitive work.

### BRIEF DESCRIPTION OF THE DRAWINGS

FIG. 1 is a block diagram of one embodiment of a local server comprising a system for submitting a patent application electronically;

FIG. 2 is a flowchart of one embodiment of a method for submitting a patent application electronically; and

FIG. 3 is a flowchart of one embodiment of details of the step of packing an application file package in FIG. 2.

### DETAILED DESCRIPTION

All of the processes described below may be embodied in, and fully automated via, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

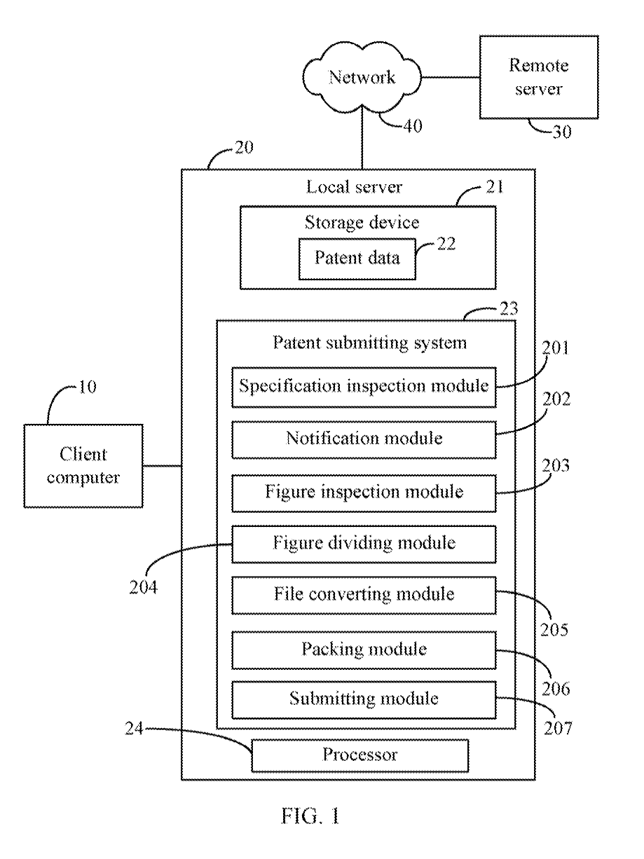

FIG. 1 is a block diagram of one embodiment of a local server 20 comprising a patent submitting system 23. The patent submitting system 23 may be used for submitting a patent application electronically. In one embodiment, the local server 20 is electronically connected to a client computer 10 and a remote server 30. Depending on the embodiment, the client computer 10 may be a personal computer (PC), a personal digital assistant (PDA), or any other computer. The remote server 30 may be a server of the United States Patent and Trademark Office (USPTO) or a server of any other designated patent office. In one embodiment, the local server 20 submits the patent application to the remote server 30 electronically over a communication network 40, where the communication network 40 may be the Internet.

The local server 20 includes a storage device 21 storing many different kinds of information, such as patent data 22. In one embodiment, the patent data 22 includes patent applications and patent details of each patent application. For example, the patent application generally includes a specification and one or more figures. The specification, as referred, includes a background, brief descriptions of the drawings, a detailed description, claims, and an abstract. The patent details include information referring to inventors, a patent type (e.g., utility and design), a designated patent attorney or patent agent, a foreign priority date, information disclosure statements (IDS), assignee(s), signature of inventors, and others.

In one embodiment, the patent submitting system 23 includes a specification inspection module 201, a notification module 202, a figure inspection module 203, a figure dividing module 204, a file converting module 205, a packing module 206, and a submitting module 207. In one embodiment, the modules 201-207 comprise computerized instructions that are stored in the storage device 21. A processor 24 of the local server 20 executes one or more computerized instructions of the patent submitting system 23 to implement one or more operations of the local server 20.

The specification inspection module 201 analyzes content and format of the specification and determines if the content and the format comply with guidelines of the designated patent office, such as the USPTO. For example, the specification inspection module 201 determines if the specification includes a background section, an abstract, and one or more claims, for example.

The notification module 202 notifies an undertaker of the patent application to revise the specification by sending an E-mail, a text message, or by any other means, if the content and/or the format of the specification do not comply with the guidelines of the designated patent office.

The figure inspection module 203 analyzes the figures of the patent application, and determines if there are two or more figures on any one page of the specification.

The figure dividing module 204 extracts each figure onto a separate page of the specification to ensure that each page contains only one figure if there are two or more figures on one page.

The file converting module 205 converts the specification and the figures of the patent application saved in storage device 21 of the local server 20 into an application body extensible (ABX) word file, and converts the ABX word file into an extensible markup language (XML) file, and a portable document format (PDF) file. The XML file converted from the ABX word file is a standard format file that also includes the specification and the figures. The PDF file, which includes the abstract, the claims, the specification, and the figures, is a backup file of the patent application.

In other embodiment, if the specification of the patent application includes one or more equations, the file converting module 205 firstly converts each equation in the specification into an image before converting the specification into the XML file, and saves the images at a specified path of the storage device 21. In one embodiment, the file converting module 205 converts each equation in the specification into a joint photographic experts group (JPEG) image. A detailed description of converting an equation into a JPEG image are as follows. The file converting module 205 converts the equation into a tag image file (TIF) image, adjusts format of the TIF image to comply with the guidelines of the designated patent office receiving the XML file, and converts the TIF image into the JPEG image.

If all the equations in the specification are converted into images, the file converting module 205 reads each element in each paragraph in the specification sequentially, and determines if the element is a text character or an equation. If the element is a text character, the file converting module 205 converts the text character into an XML character in an XML character string. If the element is an equation, the file converting module 205 reads a corresponding image of the equation according to the specified path of the image, and appends the image of the equation to the XML character string.

The packing module 206 downloads the patent details of the patent application from the storage device 21 and inputs the patent details to each textbox on a patent submission webpage of the designated patent office website automatically.

The packing module 206 packs the XML file, the PDF file, and the patent details into an application file package. Herein, the packing module 206 downloads the patent details from the storage device 21, reads a title of the patent application and the number of the claims from the XML file and the PDF file, and creates XML nodes of the patent details for the XML file. The XML nodes are used for formatting the XML file, where the XML nodes include inventor information, the designated attorney or agent, the foreign priority, the IDS, the assignee, the signature of inventors, and so on, as mentioned above.

The submitting module 207 transfers the application file package to the remote server 30 located at the designated patent office via the communication network 40.

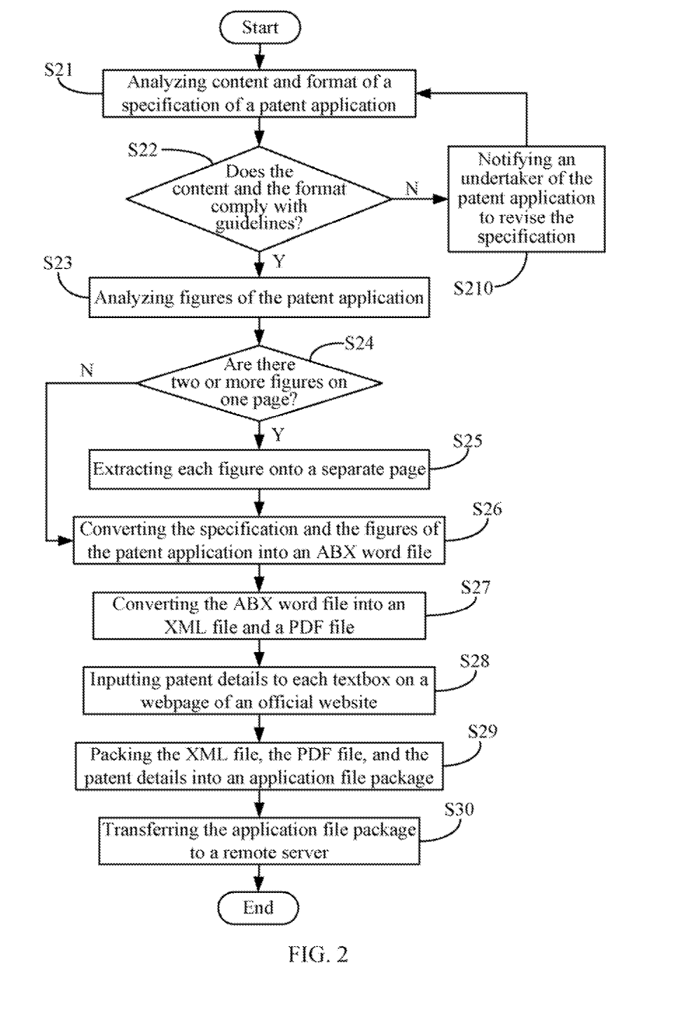

FIG. 2 is a flowchart of one embodiment of a method for submitting a patent application file electronically. In block S21, the specification inspection module 201 analyzes content and format of a specification of a patent application.

In block S22, the specification inspection module 201 determines if the content and the format comply with the guidelines of the designated patent office, such as the USPTO. If the content and format of the specification comply with the guidelines of the designated patent office, the procedure goes to block S23. Otherwise, the procedure goes to block S210 if the content and format of the specification do not comply with the guidelines of the designated patent office.

In block S23, the figure inspection module 203 analyzes figures of the patent application.

In block S24, the figure inspection module 203 determines if there are two or more figures on any one page of the specification. If there are two or more figures on one page, the procedure goes to block S25. Otherwise, the procedure goes to block S26 if each page includes only one figure.

In block S25, the figure dividing module 204 extracts each figure onto a separate page of the specification to ensure that each page contains only one figure.

In block S26, the file converting module 205 converts the specification and the figures of the patent application saved in the storage device 21 into an application body extensible (ABX) word file.

In block S27, the file conversion module 205 converts the ABX word file into an extensible markup language (XML) file and a portable document format (PDF) file. In other embodiment, if the specification of the patent application includes one or more equations, the file converting module 205 first converts each equation in the specification into an image before converting the specification into the XML file, and saves the images at a specified path of the storage device 21. A detailed description of converting the equation into the image refers to paragraph is explained above. If all the equations in the specification are converted into images, the file converting module 205 reads each element in each paragraph in the specification sequentially, and determines if the element is a text character or an equation. If the element is a text character, the file converting module 205 converts the text character into an XML character in an XML character string. If the element is an equation, the file converting module 205 reads the corresponding image of the equation according to the specified path of the image, and appends the image of the equation to the XML character string.

In block S28, the packing module 206 downloads the patent details of the patent application from the storage device 21, and inputs the patent details to each textbox on a patent submission webpage of a designated patent office website automatically.

In block S29, the packing module 206 packs the XML file, the PDF file, and patent details into an application file package.

In block S30, the submitting module 207 transfers the application file package to the remote server 30 located at the designated patent office via the communication network 40.

In block S210, the notification module 202 notifies the undertaker of the patent application to revise the specification, and the procedure returns to the block S21.

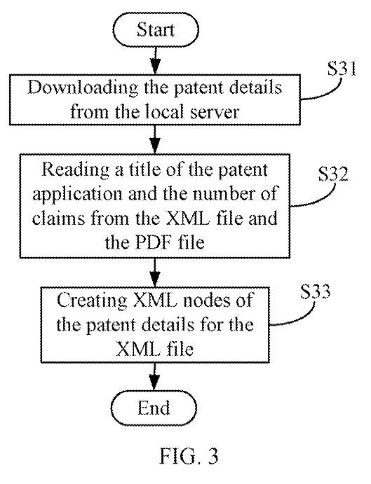

FIG. 3 is a flowchart of one embodiment of the step of packing an application file package of FIG. 2. In block S31, the packing module 206 downloads the patent details from the storage device 21.

In block S32, the packing module 206 reads a title of the patent application and the number of claims, from the XML file and the PDF file.

In block S33, the packing module 206 creates XML nodes of the patent details for the XML file. The XML nodes are used for formatting the XML file, where the XML nodes include inventor information, the designated attorney or agent, the foreign priority, the information disclosure statement (IDS), the assignee, the signature of the inventors, and so on.

The present embodiment automatically inputs patent details to each textbox on a patent submission webpage of an official website, converts a patent application to an application file package, and transfers the application file package to the designated patent office, such as USPTO.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for submitting a patent application electronically, the method comprising:
converting a specification and figures of the patent application saved in a storage device into an application body extensible (ABX) word file;
converting the ABX word file into an extensible markup language (XML) file and a portable document format (PDF) file;
downloading patent details of the patent application from the storage device, and inputting the patent details to each textbox on a patent submission webpage of a designated patent office website;
reading a title of the patent application and the number of claims from the XML file and the PDF file, and creating XML nodes of the patent details for the XML file, wherein the XML nodes are used for formatting the XML file;
packing the XML file, the PDF file and the patent details into an application file package; and
transferring the application file package to a remote server located at the designated patent office via a communication network.

2. The method according to claim 1, further comprising:
determining if the specification comprises one or more equations;
in response to the specification comprising one or more equations, converting each equation into an image before converting the specification into the XML file, and saving the images at a specified path of the storage device;
reading each element in each paragraph in the specification sequentially if all the equations in the specification are converted into images, and determining if the element is a text character or an equation;
converting the text character into an XML character in an XML character string if the element is a text character; and
reading a corresponding image of the equation according to the specified path of the image if the element is an equation, and appending the image of the equation to the XML character string.

3. The method according to claim 2, wherein converting each equation in the specification of the patent application into an image comprises converting each equation in the specification into a joint photographic experts group (JPEG) image.

4. The method according to claim 3, wherein converting each equation in the specification into a JPEG image comprises:
converting the equation into a tag image file (TIF) image;
adjusting format of the TIF image to comply with guidelines of the designated patent office receiving the XML file; and
converting the TIF image into a JPEG image.

5. The method according to claim 1, wherein the patent details comprise inventor information, a patent type, a designated patent attorney or patent agent, a foreign priority data, information disclosure statements (IDS), assignee(s), and signature of inventors.

6. The method according to claim 1, further comprising:
analyzing content and format of the specification of the patent application;
determining if the content and the format comply with guidelines of the designated patent office;
analyzing the figures of the patent application if the content and the format comply with the guidelines of the designated patent office;
determining if two or more figures appear on any one page of the specification; and
if two or more figures appear on any one page, extracting each figure onto a separate page of the specification.

7. The method according to claim 6, further comprising:
notifying an undertaker of the patent application if the content and/or the format do not comply with the guidelines of the designated patent office.

8. A storage medium having stored thereon instructions that, when executed by a processor of a computer, cause the processor to perform a method for submitting a patent application electronically, the method comprising:
converting a specification and figures of the patent application saved in a storage device into an application body extensible (ABX) word file;
converting the ABX word file into an extensible markup language (XML) file and a portable document format (PDF) file;
downloading patent details of the patent application from the storage device, inputting the patent details to each textbox on a patent submission webpage of a designated patent office website;
reading a title of the patent application and the number of claims from the XML file and the PDF file, and creating XML nodes of the patent details for the XML file, wherein the XML nodes are used for formatting the XML file;
packing the XML file, the PDF file and the patent details into an application file package; and
transferring the application file package to a remote server located at the designated patent office via a communication network.

9. The storage medium according to claim 8, wherein the method of submitting a patent application electronically further comprises:
determining if the specification comprises one or more equations;
in response to the specification comprising one or more equations, converting each equation into an image before converting the specification into the XML file, and saving the images at a specified path of the storage device;
reading each element in each paragraph in the specification sequentially if all the equations in the specification are converted into images, and determining if the element is a text character or an equation;
converting the text character into an XML character in an XML character string if the element is a text character; and
reading a corresponding image of the equation according to the specified path of the image if the element is an equation, and appending the image of the equation to the XML character string.

10. The storage medium according to claim 9, wherein converting each equation in the specification of the patent application into an image comprises converting each equation in the specification into a joint photographic experts group (JPEG) image.

11. The storage medium according to claim 10, wherein converting each equation in the specification into a JPEG image comprises:
converting the equation into a tag image file (TIF) image;
adjusting format of the TIF image to comply with guidelines of the designated patent office receiving the XML file; and
converting the TIF image into a JPEG image.

12. The storage medium according to claim 8, wherein the patent details comprise inventor information, a patent type, a designated patent attorney or patent agent, a foreign priority data, information disclosure statements (IDS), assignee(s), and signature of inventors.

13. The storage medium according to claim 8, wherein the method of submitting a patent application electronically further comprises:
analyzing content and format of the specification of the patent application;
determining if the content and the format comply with the guidelines of the designated patent office, and notifying an undertaker of the patent application if the content and/or the format do not comply with the guidelines of the designated patent office;
analyzing the figures of the patent application if the content and the format comply with the guidelines of the designated patent office;
determining if two or more figures appear on any one page of the specification; and
extracting each figure onto a separate page of the specification if two or more figures appear on any one page.

14. The storage medium according to claim 8, wherein the medium is selected from the group consisting of a hard disk drive, a compact disc, a digital video disc, and a tape drive.

15. A computing system for submitting a patent application electronically, comprising:
a file converting module operable to convert a specification and figures of the patent application saved in a storage device into an application body extensible (ABX) word file;
the file converting module further operable to convert the ABX word file into an extensible markup language (XML) file and a portable document format (PDF) file;
a packing module operable to download patent details of the patent application from the storage device, and input the patent details to each textbox on a patent submission webpage of a designated patent office website;
the packing module further operable to read a title of the patent application and the number of claims from the XML file and the PDF file, and create XML nodes of the patent details for the XML file, wherein the XML nodes are used for formatting the XML file;
packing the XML file, the PDF file and the patent details into an application file package; and
a submitting module operable to transfer the application file package to the remote server located at a designated patent office via a communication network.

16. The system according to claim 15, wherein the file converting module is further operable to:
determining if the specification comprises one or more equations;
in response to the specification comprising one or more equations, converting each equation in the specification of the patent application into an image before converting the specification into the XML file, and save the images at a specified path of the storage device;
read each element in each paragraph in the specification sequentially if all the equations in the specification are converted into images, and determine if the element is a text character or an equation;
convert the text character into an XML character in an XML character string if the element is a text character; and
read a corresponding image of the equation according to the specified path of the image if the element is an equation, and append the image of the equation to the XML character string.

17. The system according to claim 16, wherein the file converting module converts each equation in the specification of the patent application into an image comprises converting each equation in the specification into a joint photographic experts group (JPEG) image.

18. The system according to claim 17, wherein the file converting module converts each equation in the specification into a JPEG image comprises:
converting the equation into a tag image file (TIF) image;
adjusting format of the TIF image to comply with guidelines of a designated patent office receiving the XML file; and
converting the TIF image into a JPEG image.

19. The system according to claim 15, wherein the patent details comprise inventor information, a patent type, a designated patent attorney or patent agent, a foreign priority data, information disclosure statements (IDS), assignee(s), and signature of inventors.

20. The system according to claim 15, further comprising:
a specification inspection module operable to analyze content and format of the specification of the patent application, and determine if the content and the format comply with guidelines of the designated patent office;
a notification module operable to notify an undertaker of the patent application if the content and/or the format do not comply with the guidelines of the designated patent office;
a figure dividing module operable to analyze the figures of the patent application if the content and the format comply with the guidelines of the designated patent office, and determine if two or more figures appear on any one page of the specification; and
a figure dividing module operable to extract each figure onto a separate page of the specification if two or more figures appear on any one page.
